(19) United States
(12) Patent Application Publication
(10) Pub. No.: US 2008/0121721 A1
(43) Pub. Date: May 29, 2008

(54) Reflective Reading Structure For Portable Computer

(76) Inventors: Chun-Hsien Chen, Hsin-Tien City (TW); Tzu-Chi Wei, Hsin-Tien City (TW)

Correspondence Address: HDSL, 4331 STEVENS BATTLE LANE, FAIRFAX, VA, 22033, US

(21) Appl. No.: 11/563,172

(22) Filed: Nov. 25, 2006

(51) Int. Cl. G06K 7/10

(52) U.S. Cl. 235/462.45

(57) ABSTRACT

A reflective reading structure with different optical paths switch for portable computer mainly takes a portable computer as main body, the front side of which a reading end is arranged and acted as an optical path for reading barcode. A securing column, respectively arranged at upper edge of two (light and right) sides of the reading end, is respectively pivoted to a long supporting frame, which has a turning function, and front side of which is finally pivoted a casting element that is corresponded to the reading end and has a turning function whereby, applying the reflecting function of the casting element and cooperating the turning function thereof, the light irradiated from the portable computer is reflected in order to scan barcodes at different positions.

### BACKGROUND OF THE INVENTION

1. Field of the Invention

The present invention generally relates to a barcode reader, in particular, to a barcode reader's structure having reading unit.

2. Description of Prior Art

Electro-optic technology has developed to a technology of high maturity so far, thus being comprehensively applied to many fields, for example, medical recording, sensing research, or data transmission, etc., in particular, to the barcode techniques of logistic control or other livelihood operation, wherein small computer is applied to read the barcode pasted upon cargo or product for processing information management thereof, whereby the time needed for human operation and management is significantly reduced and the working efficiency is considerably enhanced.

Currently, there are two kinds of optical scanning assembly commonly installed in this portable computer (i.e., the so-called “barcode reader”) generally used for barcode reading: in the first method, after light is irradiated from the light source in the portable computer, it is directly incident upon the barcode to be read, then through internal lens the barcode image created by the light is cast upon a charge coupled device (CCD), which will read the received image; in another method commonly seen in current market, a light point is used for scanning the barcode, then the reflected light enters the CCD, which in turn will read the received barcode image as well.

However, one common point in aforementioned two manners of optically scanning assembly is that a light must be irradiated from the interior of portable computer and directly incident upon the barcode in order to read the information represented by the barcode; however, there is no particular regulation for pasting the barcode at same position in most cargos or products so far, therefore, when the user wanting to read barcode with the portable computer, he having to hold the portable computer corresponding to different positions of barcode, it frequently happening that the barcode can not be corresponded or scanned exactly, or the position of barcode must be readjusted for proceeding further reading job; owing to the incident light emitted from the portable computer being a light of straight line, therefore, when reading the barcode is occurred at different position, it has to turn around the portable computer, it making user difficult in reading barcode with portable computer, so this only shortcoming become a problem to be urgently solved by the person skilled in this art.

### SUMMARY OF THE INVENTION

Regarding aforementioned drawback, the present invention is to provide a reflective reading structure with switching optical path for portable computer. On the light-casting path formed by the light irradiated from portable computer, a casting element having turning function is arranged. When reading the barcodes at different positions, it is unnecessary for the user to adjust the position of portable computer, instead a casting element being used to adjust the path of casting light, so the barcodes at different positions may be read, the working convenience thus being enhanced.

The present invention provides a reflective reading structure for portable computer. The structure takes a portable computer as main body, the front side of which a reading end is arranged and acted as an optical path for reading barcode. A securing column, respectively arranged at upper edge of two (light and right) sides of the reading end, is respectively pivoted to a long supporting frame, which has a turning function, and front side of which is finally pivoted a casting element that is corresponded to the reading end and has a turning function whereby, applying the reflecting function of the casting element and cooperating the turning function thereof, the light irradiated from the portable computer is reflected in order to change the optically reading path.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective explosion view of the present invention;

FIG. 2 is a perspective assembly view of the present invention;

FIG. 3 is one operationally sequential illustration of the present invention;

FIG. 4 is another operationally sequential illustration of the present invention; and

FIG. 5 is an operational illustration of the present invention.

### DETAILED DESCRIPTION OF THE INVENTION

In cooperation with attached drawings, the technical contents and detailed description of the present invention will be as follows.

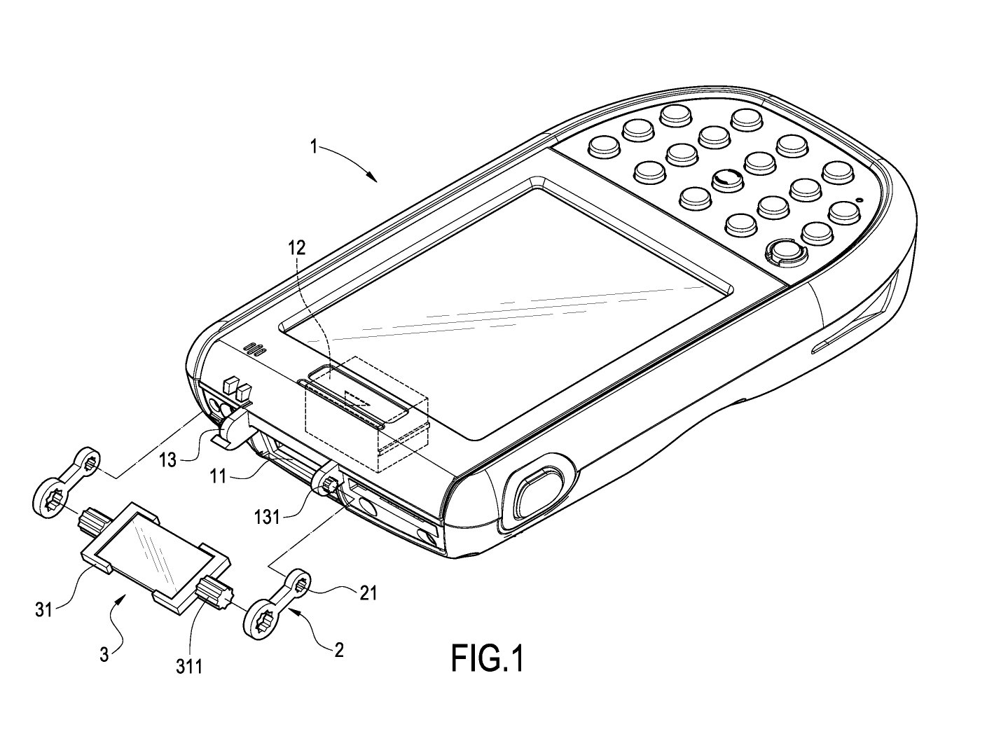

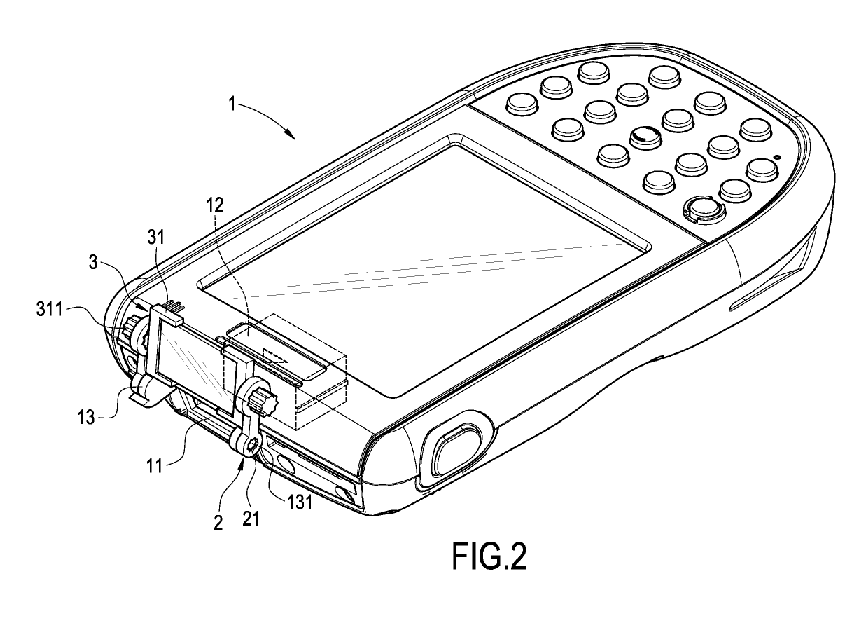

Please refer to FIG. 1 and FIG. 2, which respectively represent a perspective structure's exploding view and an assembly illustration of the present invention. As shown in FIG. 1, the structure of the present invention takes a portable computer 1 as main body, which is a barcode reader in this embodiment, and the front surface of which is arranged a reading end 11, and inside of which a sensing element 12 is also arranged. The sensing element 12 is corresponded to the reading end 11, and thus the casting light emitted from the sensing element 12 passes out from the reading end 11 (this belongs to prior arts, and there is no repetitiousness herein); furthermore, at least one supporting frame 2 is arranged at the reading end 11, in this embodiment, a securing column 13 protruded outwardly being first respectively arranged at two (left and right) sides of the reading end 11, while a pivot 131 being respectively arranged at outside surface of each securing column 13, the circumferential surface of pivot 131 being designed as teeth form; each securing column 13 is respectively pivoted a long supporting frame 2, front and rear sides of which are respectively arranged a though hole 21, internal surface of which is also designed as teeth form, wherein the rear side of though hole 21 is pivoted to the pivot 131 of securing column 13, and thus the supporting frame 2 possesses a rotating function, through the inter-engagement of the teeth structure arranged respectively at pivot 131 and though hole 21, the supporting frame 2 being able to be secured at different angles; at last, a casting element 3 is connected to the front side of the supporting frame 2, in this embodiment, it being a double-face mirror, two (left and right) sides of which is respectively arranged a securing frame 31, on the outside surface of which a protrusive column 311 extended outwardly is arranged, the circumferential surface of protrusive column 311 being designed as teeth form and being pivoted with the front side though hole 211 of the supporting frame 2, and thus the teeth structure on the protrusive column 311 and the teeth structure on the internal surface of though hole 21 are inter-engaged, such that the casting element 3 has a function of turning around and, regarding different angles of rotation, those teeth structures may be applied to secure the position thereof; FIG. 2 shows its completely assembled structure.

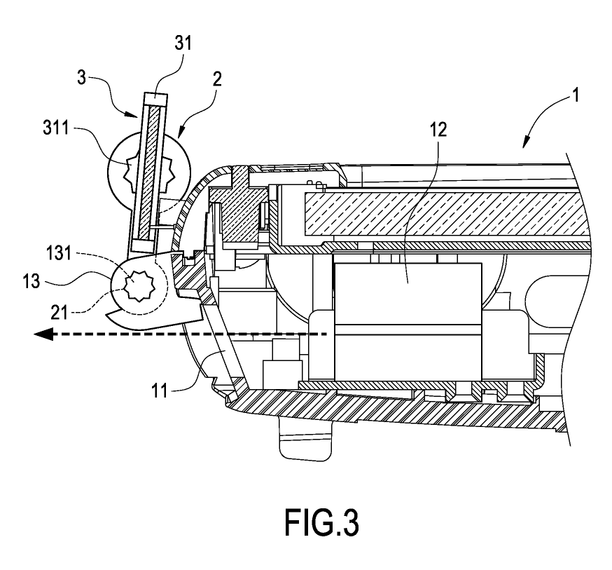

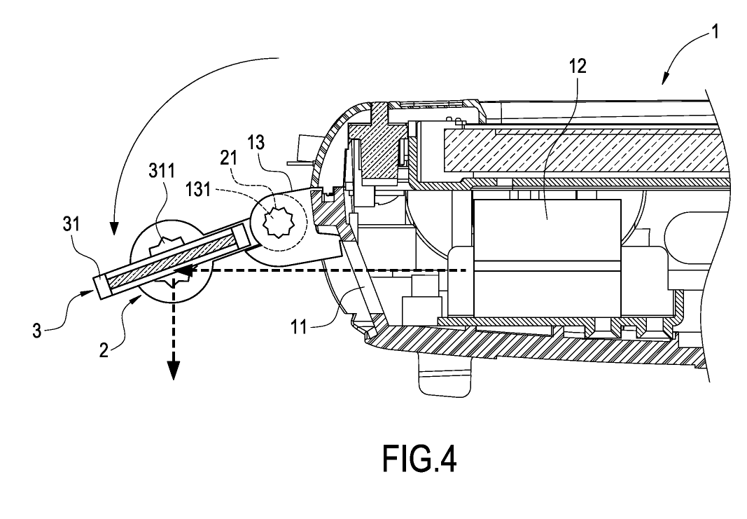

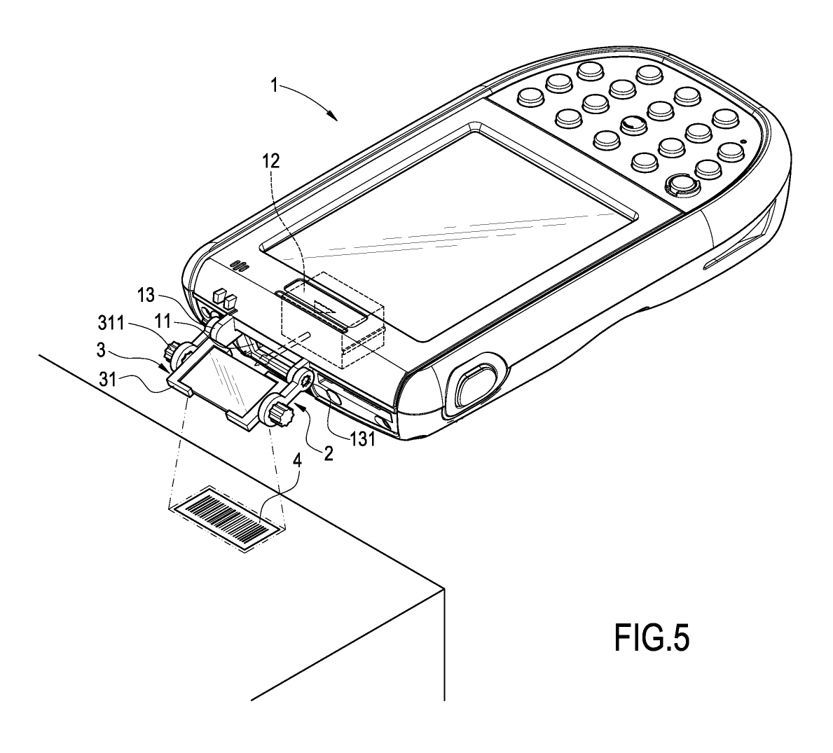

Please refer to FIG. 3 through FIG. 5, which separately are operationally sequential illustrations and operational illustration of one preferable embodiment according to the present invention. As shown in FIG. 3, when a user operates the portable computer 1 to read a barcode information, owing to the casting light irradiated from the sensing element 12 installed in the portable computer 1 being in a form of straight line (as the arrow shown in the figure), if the barcode to be read is just on the path of casting light, then the user can bend the casting element 3 arranged at the portable computer 1 upwardly to a fixed position by the rotating action of the supporting frame 2, whereby the casting light irradiated from the sensing element 12 can be directly incident upon the barcode; on the other hand, as shown in FIG. 4 and FIG. 5, if the position of barcode 4 to be read is not just on the path of cast light irradiated from the reading end 11, as indicated in FIG. 5, then the position of supporting frame 2 may be adjusted to move the casting element 3 to the optical path of original cast light, the mirror angle of casting element 3 being further adjusted, such that the casting light irradiated from the sensing element 12 installed in the portable computer (as shown by the arrow) is exactly incident upon the position of barcode 4 to be read, after the light passing out from the reading end 11 and through the reflection operation of the mirror surface of the casting element 3, the portable computer 1 being made to read the corresponding information of the barcode 4.

Aforementioned structures are only preferable embodiment according to the present invention, being not used to limit its executing scope. Any equivalent variation and modification made according to appended claims is all covered by the claims claimed by the present invention.

What is claimed is:

1. A reflective reading structure for portable computer being arranged at a reading end of the portable computer, comprising:
at least one supporting frame connected to the reading end and having turning function; and
a casting element connected to the supporting frame and having turning function;
wherein a casting light irradiated from the reading end of the portable computer is reflected with different angles and incident upon different positions, by adjusting the positions of the casting element.

2. The reflective reading structure for portable computer according to claim 1, wherein a securing column is arranged at each upper edge of two sides of the reading end of the portable computer, the outer edge of the securing column being arranged pivot, furthermore, two sides of the supporting frame being respectively arranged though hole, the though hole of one side being pivoted with the pivot.

3. The reflective reading structure for portable computer according to claim 1, wherein a securing frame is respectively arranged at two sides of the casting element, the securing frame having protrusive column extended outwardly and pivoted to another though hole of the supporting frame.

4. The reflective reading structure for portable computer according to claim 1, wherein the casting element is a double-face mirror.

5. The reflective reading structure for portable computer according to claim 2, wherein the internal surface of the though hole and the circumferential surface of the pivot are designed as a teeth form.

6. The reflective reading structure for portable computer according to claim 3, wherein the circumferential surface of the protrusive column is designed as a teeth form.
